(19) United States
(12) Patent Application Publication
(10) Pub. No.: US 2026/0273594 A1
(43) Pub. Date: Sep. 17, 2026

(54) METHOD FOR CLEANING HIGH-PRESSURE GAS CONTAINER

(71) Applicant: Resonac Corporation, Tokyo (JP)

(72) Inventors: Daichi KAWAUCHI, Tokyo (JP); Tomokazu SUGAWARA, Tokyo (JP); Kazunari KAGA, Tokyo (JP)

(73) Assignee: Resonac Corporation, Tokyo (JP)

(21) Appl. No.: 19/469,143

(22) PCT Filed: Jun. 26, 2024
(86) PCT No.: PCT/JP2024/023172

§ 371 Date: Sep. 25, 2025

(30) Foreign Application Priority Data
Jul. 13, 2023 (JP) 2023-115374

(51) Int. Cl. B08B 9/08; F17C 13/00

(52) U.S. Cl. CPC B08B 9/08; F17C 13/00; B08B 2209/08; F17C 2201/056; F17C 2221/05; F17C 2223/035; F17C 2260/05; F17C 2270/0518

(57) ABSTRACT

A method for cleaning a high-pressure gas container includes a depressurization step of reducing the pressure in a high-pressure gas container until the internal pressure reaches 5 Pa or less and a cleaning step of cleaning the inside of the high-pressure gas container after the depressurization step. The cleaning step includes a hydrogen halide supply stage of supplying a hydrogen halide to the high-pressure gas container after the depressurization step, a metal oxide removal stage of reacting, in the high-pressure gas container after the hydrogen halide supply stage, a metal oxide on the inner face of the high-pressure gas container with the hydrogen halide supplied in the hydrogen halide supply stage to form water, and a discharge stage of discharging the water formed in the metal oxide removal stage and the hydrogen halide supplied in the hydrogen halide supply stage from the high-pressure gas container.

### TECHNICAL FIELD

The present disclosure relates to a method for cleaning a high-pressure gas container.

### BACKGROUND ART

A hydrogen halide (HX) used in semiconductor manufacturing processes is preferably anhydrous and is required to have a moisture concentration of, for example, 1.0 ppm by volume or less. However, when a metal oxide (for example, ferrous oxide (FeO)) is on the inner face of a high-pressure gas container to be filled with a hydrogen halide, the charged hydrogen halide reacts with the metal oxide to form a metal halide (for example, ferrous chloride (FeCl₂)) and water (H₂O). Why a metal oxide is on the inner face of a high-pressure gas container is thought that, for example, during open inspections conducted at the time of purchase, pressure-resistant tests, or the like of a high-pressure gas container, a metal contained in the material of the high-pressure gas container is oxidized by atmospheric air to yield a metal oxide.

To remove a metal oxide on the inner face of a high-pressure gas container, a removal method by reacting the metal oxide with a hydrogen halide is used. For example, PTL 1 discloses a method that includes supplying liquefied hydrogen chloride to a high-pressure gas container, reacting a metal oxide on the inner face of the high-pressure gas container with the liquefied hydrogen chloride at a temperature of 30° C. or more and 50° C. or less to form water, and then discharging the liquefied hydrogen chloride containing the formed water from the high-pressure gas container.

### CITATION LIST

### Patent Literature

PTL 1: JP 2002-54799 A

### SUMMARY OF INVENTION

### Technical Problem

The technology disclosed in PTL 1 may insufficiently suppress the formation of water depending on the temperature at which a metal oxide on the inner face of a high-pressure gas container is reacted with liquefied hydrogen chloride, and thus has a room for improvement.

It is an object of the present disclosure to provide a method for cleaning a high-pressure gas container capable of suppressing the formation of water in the high-pressure gas container.

### Solution to Problem

To solve the problems, aspects of the present disclosure are the following [1] to [10].

[1]A method for cleaning a high-pressure gas container including:
a depressurization step of reducing the pressure in a high-pressure gas container until an internal pressure of the high-pressure gas container reaches 5 Pa or less; and
a cleaning step of cleaning the inside of the high-pressure gas container after the depressurization step, in which
the cleaning step includes
a hydrogen halide supply stage of supplying a hydrogen halide to the high-pressure gas container after the depressurization step,
a metal oxide removal stage of reacting, in the high-pressure gas container after the hydrogen halide supply stage, a metal oxide on the inner face of the high-pressure gas container with the hydrogen halide supplied in the hydrogen halide supply stage to form water, and
a discharge stage of discharging the water formed in the metal oxide removal stage and the hydrogen halide supplied in the hydrogen halide supply stage from the high-pressure gas container.

[2] The method for cleaning a high-pressure gas container according to the aspect [1], in which the inner face of the high-pressure gas container is not coated with any coating material, and the inner face of the body of the high-pressure gas container has a maximum height Rz of 5 μm or less.

[3] The method for cleaning a high-pressure gas container according to the aspect [1] or [2], in which the depressurization step is a step of discharging gas until the internal pressure reaches 5 Pa or less while the high-pressure gas container is maintained at a temperature of 50° C. or more and 200° C. or less.

[4] The method for cleaning a high-pressure gas container according to any one of the aspects [1] to [3], in which the hydrogen halide is at least one of hydrogen fluoride, hydrogen chloride, hydrogen bromide, and hydrogen iodide.

[5] The method for cleaning a high-pressure gas container according to any one of the aspects [1] to [4], in which the hydrogen halide supply stage is a step of supplying a hydrogen halide to the high-pressure gas container until the hydrogen halide is liquefied in the high-pressure gas container.

[6] The method for cleaning a high-pressure gas container according to any one of the aspects [1] to [5], in which the metal oxide removal stage is a step of allowing the high-pressure gas container to which the hydrogen halide has been supplied in the hydrogen halide supply stage, to stand at a temperature of less than 30° C. for one day or more.

[7] The method for cleaning a high-pressure gas container according to any one of the aspects [1] to [6], in which when the high-pressure gas container has a volume of 10 L or more and 50 L or less, the discharge stage is a step of turning the high-pressure gas container upside down to discharge the water and the hydrogen halide from the high-pressure gas container.

[8] The method for cleaning a high-pressure gas container according to any one of the aspects [1] to [6], in which when the high-pressure gas container has a volume of more than 50 L and 1000 L or less, the discharge stage is a step of inserting an insertion tube into the high-pressure gas container and using the insertion tube to discharge the water and the hydrogen halide in the liquid phase from the high-pressure gas container.

[9] The method for cleaning a high-pressure gas container according to any one of the aspects [1] to [8], in which after the depressurization step, the cleaning step is repeated twice or more.

[10] The method for cleaning a high-pressure gas container according to any one of the aspects [1] to [9], in which the metal oxide is at least one of iron oxide, chromium oxide, molybdenum oxide, and manganese oxide.

### Advantageous Effects of Invention

By using the method for cleaning a high-pressure gas container according to the present disclosure to clean the inside of a high-pressure gas container, the formation of water in the high-pressure gas container can be suppressed.

### BRIEF DESCRIPTION OF DRAWINGS

FIG. 1 is a schematic view illustrating an example apparatus for performing a hydrogen halide supply stage and a discharge stage in a method for cleaning a high-pressure gas container according to an embodiment of the present disclosure;

FIG. 2 is a schematic view illustrating an example apparatus for performing a depressurization step in a method for cleaning a high-pressure gas container according to an embodiment of the present disclosure;

FIG. 3 is a sectional view illustrating an example high-pressure gas container usable in a method for cleaning a high-pressure gas container according to an embodiment of the present disclosure;

FIG. 4 is a sectional view illustrating an example high-pressure gas container usable in a method for cleaning a high-pressure gas container according to an embodiment of the present disclosure;

FIG. 5 is a graph illustrating the relationship between the number of times of the cleaning step and the amount of water discharged in the discharge stage; and

FIG. 6 is a graph illustrating the relationship between the days elapsed after filling with a hydrogen chloride and the moisture concentration of the hydrogen chloride.

### DESCRIPTION OF EMBODIMENTS

One embodiment of the present disclosure will now be described. The embodiment is merely one example of the present disclosure, and the present disclosure is not limited to the embodiment. Various modifications or improvements can be made in the embodiment, and such modifications and improvements can be encompassed by the present disclosure.

A method for cleaning a high-pressure gas container according to the present embodiment includes a depressurization step of reducing the pressure in a high-pressure gas container until the internal pressure reaches 5 Pa or less and a cleaning step of cleaning the inside of the high-pressure gas container after the depressurization step. The cleaning step includes a hydrogen halide supply stage of supplying a hydrogen halide to the high-pressure gas container after the depressurization step, a metal oxide removal stage of reacting, in the high-pressure gas container after the hydrogen halide supply stage, a metal oxide on the inner face of the high-pressure gas container with the hydrogen halide supplied in the hydrogen halide supply stage to form water, and a discharge stage of discharging the water formed in the metal oxide removal stage and the hydrogen halide supplied in the hydrogen halide supply stage from the high-pressure gas container.

The method for cleaning a high-pressure gas container according to the present embodiment includes a depressurization step of reducing the pressure in a high-pressure gas container until the internal pressure reaches 5 Pa or less and a cleaning step of cleaning the inside of the high-pressure gas container after the depressurization step.

The cleaning step includes a hydrogen halide supply stage, a metal oxide removal stage, and a discharge stage. The hydrogen halide supply stage is a step of supplying a hydrogen halide to the high-pressure gas container after the depressurization step. The metal oxide removal stage is a step of reacting, in the high-pressure gas container after the hydrogen halide supply stage, a metal oxide on the inner face of the high-pressure gas container with the hydrogen halide supplied in the hydrogen halide supply stage to form water. The discharge stage is a step of discharging the water formed in the metal oxide removal stage and the hydrogen halide supplied in the hydrogen halide supply stage from the high-pressure gas container.

The method for cleaning a high-pressure gas container according to the present embodiment includes the depressurization step and the cleaning step. Hence, by using the method for cleaning a high-pressure gas container according to the present embodiment to clean the inside of a high-pressure gas container, a metal oxide that is to form water is removed, and the formation of water in the high-pressure gas container can be suppressed.

Such a method for cleaning a high-pressure gas container according to the present embodiment is suitable as the method for cleaning a high-pressure gas container that is to be filled with and to store a hydrogen halide used for semiconductor manufacturing processes. In the high-pressure gas container cleaned by the method for cleaning a high-pressure gas container according to the present embodiment, water is unlikely to be formed, and thus a charged hydrogen halide can be maintained to have a low moisture concentration (for example, 1.0 ppm by volume or less). More specifically, by using the high-pressure gas container cleaned by the method for cleaning a high-pressure gas container according to the present embodiment, a high-quality hydrogen halide can be prepared.

For the hydrogen halide used in semiconductor manufacturing processes, the concentration of molecular hydrogen (H₂) is also restricted and is, for example, required to be reduced to 10 ppm by volume or less. It is however known that the reaction of a zero-valent metal (for example, iron) on the inner face of a high-pressure gas container with a hydrogen halide yields ferrous chloride and molecular hydrogen. The reaction of forming molecular hydrogen is an endothermic reaction and thus proceeds more easily as the reaction temperature increases. Hence, for example, the method according to PTL 1 is a method in which a high-pressure gas container containing a hydrogen halide is heated, and thus may promote the formation of molecular hydrogen, unfortunately.

The method for cleaning a high-pressure gas container according to the present embodiment eliminates the need of heating a high-pressure gas container containing a hydrogen halide, and accordingly suppresses the formation of molecular hydrogen. This can suppress an increase in the concentration of molecular hydrogen in a hydrogen halide and can maintain the concentration at 10 ppm by volume or less.

As a high-pressure gas container becomes larger, heat treatment of the high-pressure gas container becomes more difficult. The method for cleaning a high-pressure gas container according to the present embodiment eliminates the need of heat treatment of a high-pressure gas container and can remove a metal oxide from the inside of a high-pressure gas container under mild conditions.

For the hydrogen halide used in semiconductor manufacturing processes, the concentration of atomic phosphorus (P) is also restricted and is, for example, required to be reduced to 2 ppb by volume or less. To suppress the reaction between the above hydrogen halide with a metal oxide, a method of coating the inner face of a high-pressure gas container with a coating material is known. For example, a method of plating the inner face of a high-pressure gas container with nickel-phosphorus alloy is known, but when the high-pressure gas container is filled with a hydrogen halide, the hydrogen halide may contain atomic phosphorus derived from the nickel-phosphorus alloy, unfortunately.

By using the method for cleaning a high-pressure gas container according to the present embodiment to clean the inside of a high-pressure gas container, the formation of water in the high-pressure gas container can be suppressed even when the inner face of the high-pressure gas container is not coated with any coating material. This can suppress an increase in the concentration of atomic phosphorus in a hydrogen halide and can maintain the concentration at 2 ppb by volume or less.

The high-pressure gas container cleaned by the method for cleaning a high-pressure gas container according to the present embodiment can be filled with not only a hydrogen halide but also various gases and can store such a gas.

Hereinafter, the method for cleaning a high-pressure gas container according to the present embodiment will be described in further detail.

### [High-Pressure Gas Container]

The high-pressure gas container used in the method for cleaning a high-pressure gas container according to the present embodiment is a container that is used for discharge or filling of a gas through a gas flow path. The high-pressure gas container used in the method for cleaning a high-pressure gas container according to the present embodiment is not particularly limited, and, for example, the size and the shape are not particularly limited. The material of the high-pressure gas container is not particularly limited, and examples include a metal material containing at least one of iron (Fe), chromium (Cr), molybdenum (Mo), and manganese (Mn).

The high-pressure gas container used in the method for cleaning a high-pressure gas container according to the present embodiment may be a new (unused) high-pressure gas container or a used high-pressure gas container. The high-pressure gas container may be a high-pressure gas container open to the atmosphere or a high-pressure gas container not open to the atmosphere.

The condition of the inner face of the high-pressure gas container is not particularly limited, and the inner face of the high-pressure gas container may be coated or not coated with a coating material. Examples of the coating material coated on the inner face of the high-pressure gas container include nickel (Ni) plating, nickel-phosphorus alloy (Ni—P) plating, zinc (Zn) plating, gold (Au) plating, and silver (Ag) plating.

The surface roughness of the inner face of the high-pressure gas container is not particularly limited, and the inner face of the body of the high-pressure gas container preferably has a maximum height Rz of 5 μm or less. The inner face of the high-pressure gas container may not be coated with any coating material, and the inner face of the body of the high-pressure gas container may have a maximum height Rz of 5 μm or less. When the inner face of the high-pressure gas container has a small surface roughness (smooth face), the quality of a hydrogen halide charged after cleaning can be maintained at a high level even when the method for cleaning a high-pressure gas container is simplified. As compared with conventional methods for cleaning a high-pressure gas container, the quality of a hydrogen halide can be improved.

The inner face of the body of the high-pressure gas container more preferably has a maximum height Rz of 1 μm or more and 5 μm or less, and the inner face of portions other than the body of the high-pressure gas container more preferably has a maximum height Rz of 15 μm or more and 20 μm or less. The inner face of the body of the high-pressure gas container even more preferably has a maximum height Rz of 1 μm or less, and the inner face of portions other than the body of the high-pressure gas container even more preferably has a maximum height Rz of 15 μm or more and 20 μm or less. The inner face of the body of the high-pressure gas container particularly preferably has a maximum height Rz of 1 μm or less, and the inner face of portions other than the body of the high-pressure gas container particularly preferably has a maximum height Rz of 1 μm or less.

The “body” of a high-pressure gas container in the present disclosure means the central portion in the long axis direction of the high-pressure gas container excluding the respective ends in the long axis direction. The end means a portion having 5% by volume of the volume of a high-pressure gas container.

For example, for a high-pressure gas container having a cylindrical shape or a prismatic shape, the body means the central portion excluding the respective ends in the height direction (length direction) of the cylinder or prism. For a high-pressure gas container having a spherical shape, the body means the central portion excluding the respective ends in the radial direction of the sphere.

The method of reducing the maximum height Rz of the inner face of the body of a high-pressure gas container is not particularly limited, and examples include a method of polishing the inner face of the body of a high-pressure gas container. Examples of the method of polishing the inner face of the body of a high-pressure gas container include shot blasting, barrel polishing, and electrolytic polishing.

The method of measuring the maximum height Rz of the inner face of the body of a high-pressure gas container is not particularly limited, and, for example, the method according to Japanese Industrial Standard JIS B0601-2013 may be used.

The measurement apparatus for measuring the maximum height Rz of the inner face of the body of a high-pressure gas container is not particularly limited, and, for example, a stylus-type surface roughness measuring instrument such as Portable Surface Roughness Measurement SURFTEST SJ-210 series manufactured by Mitutoyo Corporation may be used.

The method for cleaning a high-pressure gas container according to the present embodiment is applicable to the cleaning of any high-pressure gas container, but is particularly suitable to clean a high-pressure gas container in which the inner face is not coated with any coating material and the inner face of the body has a maximum height Rz of 5 μm or less.

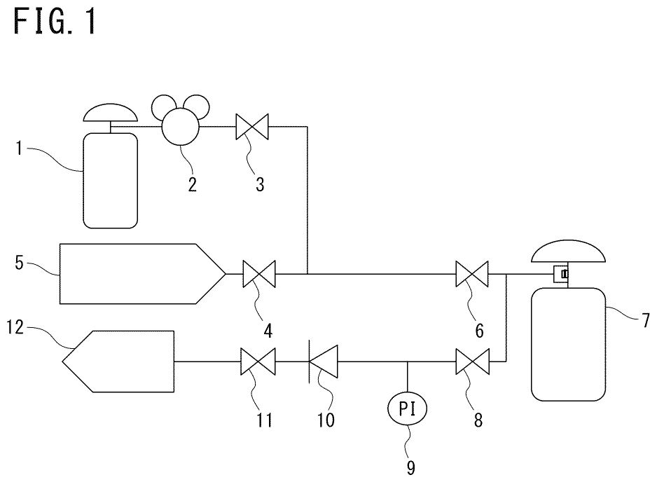

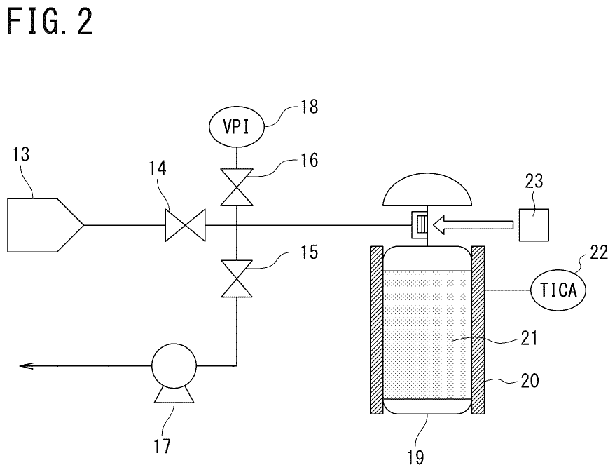

With reference to FIG. 1 and FIG. 2, an example of the method for cleaning a high-pressure gas container according to the present embodiment will next be described.

### [Depressurization Step]

For the high-pressure gas container to be subjected to the cleaning step, water in the container is required to be removed in advance by the depressurization step of reducing the pressure in a high-pressure gas container until the internal pressure reaches 5 Pa or less. FIG. 2 is a view illustrating an example apparatus for performing the depressurization step on a high-pressure gas container having a volume of 10 L or more and 50 L or less. With reference to FIG. 2, the depressurization step will be described.

The depressurization step is performed to reduce the pressure in the high-pressure gas container 19 having, for example, a volume of 47 L. More specifically, a vacuum pump 17 is used to discharge water and other gases in the high-pressure gas container 19. The depressurization step is performed to discharge gases until the internal pressure reaches 5 Pa or less while the high-pressure gas container 19 is preferably maintained at a temperature of 50° C. or more and 200° C. or less, more preferably at a temperature of 100° C. or more and 200° C. or less, and even more preferably at a temperature of 150° C. or more and 200° C. or less. The temperature of a high-pressure gas container 19 may be controlled by heating the high-pressure gas container 19 with, for example, a heater 20 provided to cover the high-pressure gas container 19.

When a high-pressure gas container 19 is heated, air is preferably blown from a fusible plug-cooling air supply source 23 to a fusible plug to cool the fusible plug so as not to activate the fusible plug provided on the valve of the high-pressure gas container 19.

The ultimate pressure in the high-pressure gas container 19 after the depressurization step is required to be 5 Pa or less, is preferably 1 Pa or less, more preferably 0.01 Pa or less, and even more preferably less than 0.01 Pa. The vacuum pump 17 is preferably a dry vacuum pump.

Before the depressurization step, an inert gas is preferably allowed to flow through piping to discharge water in the piping. The type of inert gas is not particularly limited, and examples include nitrogen gas (Nd), helium (He), argon (Ar), and xenon (Xe). In FIG. 2, nitrogen gas is used as the inert gas as an example, and an inert gas may be allowed to flow from a nitrogen gas supply source 13 through the piping.

The moisture concentration in the inert gas such as nitrogen gas used here is preferably 1 ppm by volume or less, more preferably 0.1 ppm by volume or less, and even more preferably 0.05 ppm by volume or less.

### [Cleaning Step]

After completion of the depressurization step, a cleaning step of cleaning the inside of the high-pressure gas container is performed. FIG. 1 is a view illustrating an example apparatus for performing the cleaning step. With reference to FIG. 1, the cleaning step will be described.

First, the high-pressure gas container 19 in which the inside has been evacuated in the depressurization step is detached from the apparatus illustrated in FIG. 2 and is attached to the apparatus illustrated in FIG. 1. In FIG. 1, the “high-pressure gas container 19” is indicated as a “high-pressure gas container 7”. Next, a hydrogen halide supply stage of supplying a hydrogen halide to the high-pressure gas container 7 is performed, but before the hydrogen halide supply stage, the following process is preferably performed. More specifically, into the piping located upstream of the high-pressure gas container 7 of the apparatus illustrated in FIG. 1, a hydrogen halide is supplied to increase the pressure to 0.1 MPaG or more, and then a discharge means 12 is used to reduce the pressure to around atmospheric pressure. The process is preferably repeated to remove air and water in the apparatus illustrated in FIG. 1.

After the above process, the hydrogen halide supply stage is performed. In the hydrogen halide supply stage, a hydrogen halide is preferably supplied to the high-pressure gas container until the hydrogen halide is liquefied in the high-pressure gas container. More specifically, a hydrogen halide is supplied from a hydrogen halide supply source 5 to the high-pressure gas container 7, and the hydrogen halide is continuously supplied until the hydrogen halide exists in the high-pressure gas container 7 in separate two phases, the gas phase and the liquid phase (until the hydrogen halide is partially liquefied). The mass of the hydrogen halide supplied to the high-pressure gas container 7 may be weighed with a scale. The mass of the hydrogen halide supplied to a high-pressure gas container 7 having a volume of 47 L is preferably 5 kg or more and 30 kg or less.

The type of hydrogen halide is not particularly limited, and may be at least one of hydrogen fluoride (HF), hydrogen chloride (HCl), hydrogen bromide (HBr), and hydrogen iodide (HI). In FIG. 1, hydrogen chloride is used as the hydrogen halide as an example.

The moisture concentration of the hydrogen halide supplied from the hydrogen halide supply source 5 to the high-pressure gas container 7 is preferably 0.2 ppm by volume or less, more preferably 0.1 ppm by volume or less, and even more preferably 0.05 ppm by volume or less.

The purity of the hydrogen halide supplied from the hydrogen halide supply source 5 to the high-pressure gas container 7 is preferably 3 N or more (99.9% by volume or more), more preferably 4 N or more (99.99% by volume or more), and even more preferably 5 N or more (99.999% by volume or more).

Before the high-pressure gas container 7 to which a hydrogen halide has been supplied is detached from the apparatus illustrated in FIG. 1, the hydrogen halide in the apparatus illustrated in FIG. 1 is preferably removed. More specifically, into the apparatus illustrated in FIG. 1, helium is supplied from a helium cylinder 1 for purging to increase the pressure in the apparatus illustrated in FIG. 1 to a pressure of 1.0 MPaG or more, and then the discharge means 12 is used to reduce the pressure to around atmospheric pressure. The process is preferably repeated to remove the hydrogen halide in the apparatus illustrated in FIG. 1.

From the apparatus illustrated in FIG. 1, the high-pressure gas container 7 is detached, and is subjected to the metal oxide removal stage. More specifically, in the high-pressure gas container 7 after the hydrogen halide supply stage, a metal oxide on the inner face of the high-pressure gas container 7 is reacted with the hydrogen halide supplied in the hydrogen halide supply stage to form water.

The type of metal oxide is not particularly limited, and examples include at least one of iron oxide, chromium oxide, molybdenum oxide, and manganese oxide.

The metal oxide removal stage may be performed by allowing the high-pressure gas container 7 after the hydrogen halide supply stage to stand at a predefined temperature for a predefined time period. The temperature in the metal oxide removal stage is preferably less than 30° C. The time period in the metal oxide removal stage is preferably one day or more, more preferably 10 days or more, and even more preferably 60 days or more. More specifically, in the metal oxide removal stage, the high-pressure gas container to which a hydrogen halide has been supplied in the hydrogen halide supply stage may be allowed to stand at a temperature of less than 30° C. for one day or more.

The method of setting the high-pressure gas container 7 at a temperature of less than 30° C. is not particularly limited, and examples include a method of using an air conditioning apparatus such as an air conditioner. In the metal oxide removal stage, the room temperature or ambient temperature of the environment in which the high-pressure gas container 7 is placed is thought to affect the reaction rate between the metal oxide and the hydrogen halide to some extent, but the effect is negligible in the temperature range of less than 30° C. Accordingly, in the temperature range of less than 30° C., the number of times of cleaning step to achieve an intended cleaning effect does not increase depending on temperatures. In the metal oxide removal stage, the inside of the high-pressure gas container 7 is a closed space and thus is hardly affected by humidity or atmosphere outside the high-pressure gas container 7.

Next, the water formed by the reaction between a metal oxide and a hydrogen halide in the metal oxide removal stage is discharged together with an excess hydrogen halide that has been supplied in the hydrogen halide supply stage but has not consumed by the reaction in the metal oxide removal stage, from the high-pressure gas container 7 in the discharge stage. In the discharge stage, a metal halide formed by the reaction between a metal oxide and a hydrogen halide in the metal oxide removal stage may also be discharged from the high-pressure gas container 7.

The apparatus illustrated in FIG. 1 is used to discharge water and a hydrogen halide from the high-pressure gas container 7. Considering the distribution coefficient of water in a hydrogen halide, water can be more efficiently discharged from the high-pressure gas container 7 by discharging a hydrogen halide containing water from the liquid phase side rather than from the gas phase side.

For example, for a high-pressure gas container having a volume of 10 L or more and 50 L or less, in the discharge stage, the high-pressure gas container is preferably turned upside down to discharge the water and the hydrogen halide from the high-pressure gas container. More specifically, a compact high-pressure gas container having a volume of 10 L or more and 50 L or less has only one container valve, and thus to discharge a hydrogen halide from the liquid phase side, the high-pressure gas container is preferably set such that the container valve faces vertically downward, and the liquefied hydrogen halide is preferably discharged from the high-pressure gas container.

A compact high-pressure gas container having a volume of 10 L or more and 50 L or less is preferably set such that the container valve faces vertically downward, but is not required to be placed upright. As long as the container valve faces vertically downward, the container may be tilted. The tilt angle is not particularly limited, but is preferably, for example, 45° or more and less than 90°.

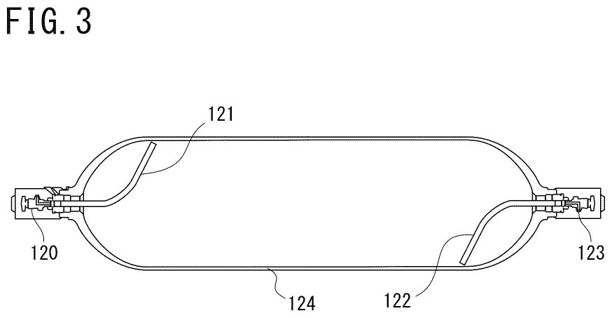

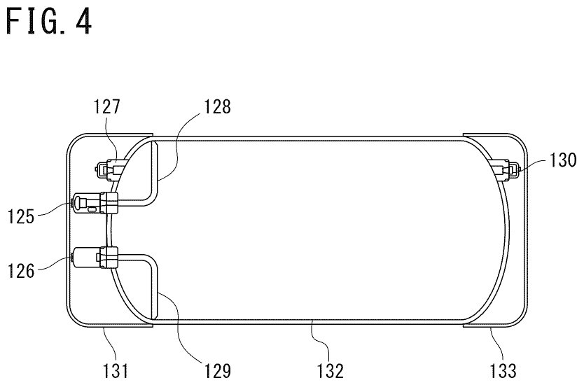

For example, for a high-pressure gas container having a volume of more than 50 L and 1000 L or less, in the discharge stage, an insertion tube is preferably inserted into the high-pressure gas container, and the insertion tube is preferably used to discharge water and a hydrogen halide in the liquid phase from the high-pressure gas container. For a high-pressure gas container 124 having a volume of 440 L illustrated in FIG. 3 or a high-pressure gas container 132 having a volume of 900 L illustrated in FIG. 4, a gas phase siphon tube 121, 128 and a liquid phase siphon tube 122, 129 are inserted into the high-pressure gas container (the gas phase siphon tube 121, 128 and the liquid phase siphon tube 122, 129 correspond to the insertion tube as a constituent element of the present disclosure). Hence, the downward-facing liquid phase siphon tube 122, 129 can be used to discharge the liquefied hydrogen halide from the liquid phase side to the outside of the high-pressure gas container 124, 132, and this enables efficient discharge of water contained in the hydrogen halide to the outside of the high-pressure gas container 124, 132.

Such a cleaning step may be performed once after the depressurization step or may be repeated twice or more after the depressurization step.

After completion of the cleaning step, the moisture concentration, the molecular hydrogen concentration, and the atomic phosphorus concentration in the hydrogen halide discharged in the discharge stage may each be determined. The moisture concentration of a hydrogen halide may be determined by using a moisture meter. As the moisture meter, a cavity ring-down spectroscopy (CRDS) analyzer may be used. The molecular hydrogen concentration of a hydrogen halide may be determined by, for example, gas chromatography (GC). As the detector for the gas chromatography, a pulsed discharge photo-ionization detector may be used. The atomic phosphorus concentration of a hydrogen halide may be determined by, for example, inductively coupled plasma atomic emission spectrometry (ICP-AES).

The high-pressure gas container cleaned as above is usable as a high-pressure gas container that is to be filled with and to store a hydrogen halide. More specifically, by filling the high-pressure gas container cleaned as above with a hydrogen halide (for example, by filling the high-pressure gas container with a hydrogen halide without exposing the high-pressure gas container after the cleaning step to the atmosphere), the moisture concentration of the charged hydrogen halide can be maintained at a low level (for example, 1.0 ppm by volume or less). The type of hydrogen halide to be filled is not particularly limited, and may be at least one of hydrogen fluoride, hydrogen chloride, hydrogen bromide, and hydrogen iodide.

### EXAMPLES

The present disclosure will be described below in further detail with reference to examples and comparative examples.

### Example 1

A metal high-pressure gas container having a volume of 47 L was prepared. The inner face of the high-pressure gas container was polished so that the inner face of the body had a maximum height Rz of 1 μm, and the inner face of portions other than the body had a maximum height Rz of 20 μm. The inner face of the high-pressure gas container was not coated with any coating material.

The high-pressure gas container was attached to the apparatus illustrated in FIG. 2 and was subjected to the depressurization step. More specifically, the depressurization step was performed to reduce the pressure until the internal pressure of the high-pressure gas container reached 0.01 Pa or less while the temperature was maintained at 145° C. or more and 155° C. or less.

Next, when the temperature of the high-pressure gas container after the depressurization step reached the normal temperature, the high-pressure gas container was detached from the apparatus illustrated in FIG. 2 and was attached to the apparatus illustrated in FIG. 1. Then, the container valve of the high-pressure gas container was closed. Hydrogen chloride was supplied into the apparatus illustrated in FIG. 1 until the pressure reached 1.80 MPaG, and the apparatus was decompressed until the residual pressure reached 0.1 MPaG. The process was repeated five times in total.

Subsequently, the high-pressure gas container was subjected to the cleaning step. More specifically, the container valve of the high-pressure gas container was opened. The high-pressure gas container was filled with 25 kg of hydrogen chloride having a moisture concentration of 0.2 ppm by volume or less (hydrogen halide supply stage), and then was allowed to stand for 24 hours while the temperature was maintained within a range of 15° C. or more and 25° C. or less (metal oxide removal stage). Then, the container valve of the high-pressure gas container was closed, and the container was detached from the apparatus illustrated in FIG. 1. The high-pressure gas container was turned upside down (such that the container valve faced vertically downward), and the container valve was opened to discharge the hydrogen chloride from the high-pressure gas container until the residual pressure reached 0.11 MPa (discharge stage). The cleaning step as above was repeated four times in total.

The high-pressure gas container after the cleaning step was refilled with 25 kg of hydrogen chloride having a moisture concentration of 0.2 ppm by volume or less. Then, the moisture concentration of the hydrogen chloride charged in the high-pressure gas container was determined with a cavity ring-down spectroscopy (CRDS) analyzer, the molecular hydrogen concentration was determined by gas chromatography (GC), and the atomic phosphorus concentration was determined by inductively coupled plasma atomic emission spectrometry (ICP-AES). As the detector for the gas chromatography, a pulsed discharge photo-ionization detector was used. As a result, the hydrogen chloride had a moisture concentration of 0.6 ppm by volume, a molecular hydrogen concentration of 0.1 ppm by volume or less, and an atomic phosphorus concentration of 0.5 ppb by volume. The results are shown in Table 1.

### Example 2

A high-pressure gas container was cleaned in the same manner as in Example 1 except that the inner face of the body and the inner face of portions other than the body each had a maximum height Rz of 1 μm, and the cleaning step was performed once.

The high-pressure gas container after the cleaning step was refilled with 25 kg of hydrogen chloride having a moisture concentration of 0.2 ppm by volume or less. Then, the moisture concentration, the molecular hydrogen concentration, and the atomic phosphorus concentration of the hydrogen chloride charged in the high-pressure gas container were determined in the same manner as in Example 1. As a result, the hydrogen chloride had a moisture concentration of 0.4 ppm by volume, a molecular hydrogen concentration of 0.1 ppm by volume or less, and an atomic phosphorus concentration of 0.9 ppb by volume. The results are shown in Table 1.

### Example 3

A high-pressure gas container was cleaned in the same manner as in Example 1 except that the inner face of the body and the inner face of portions other than the body each had a maximum height Rz of 5 μm, and the cleaning step was performed twice.

The high-pressure gas container after the cleaning step was refilled with 25 kg of hydrogen chloride having a moisture concentration of 0.2 ppm by volume or less. Then, the moisture concentration, the molecular hydrogen concentration, and the atomic phosphorus concentration of the hydrogen chloride charged in the high-pressure gas container were determined in the same manner as in Example 1. As a result, the hydrogen chloride had a moisture concentration of 0.8 ppm by volume, a molecular hydrogen concentration of 1.0 ppm by volume, and an atomic phosphorus concentration of 0.7 ppb by volume. The results are shown in Table 1.

### Example 4

A high-pressure gas container was cleaned in the same manner as in Example 1 except that the hydrogen halide used in the cleaning step was changed from hydrogen chloride having a moisture concentration of 0.2 ppm by volume or less to hydrogen bromide having a moisture concentration of 0.2 ppm by volume or less, and the amount of hydrogen bromide supplied in the hydrogen halide supply stage was 20 kg.

The high-pressure gas container after the cleaning step was refilled with 20 kg of hydrogen bromide having a moisture concentration of 0.2 ppm by volume or less. Then, the moisture concentration, the molecular hydrogen concentration, and the atomic phosphorus concentration of the hydrogen bromide charged in the high-pressure gas container were determined in the same manner as in Example 1. As a result, the hydrogen bromide had a moisture concentration of 0.9 ppm by volume, a molecular hydrogen concentration of 0.1 ppm by volume or less, and an atomic phosphorus concentration of 0.9 ppb by volume. The results are shown in Table 1.

### Example 5

A high-pressure gas container was cleaned in the same manner as in Example 1 except that the cleaning step was performed once, and the temperature in the metal oxide removal stage was changed to 35° C. or more and 40° C. or less.

The high-pressure gas container after the cleaning step was refilled with 25 kg of hydrogen chloride having a moisture concentration of 0.2 ppm by volume or less. Then, the moisture concentration, the molecular hydrogen concentration, and the atomic phosphorus concentration of the hydrogen chloride charged in the high-pressure gas container were determined in the same manner as in Example 1. As a result, the hydrogen chloride had a moisture concentration of 0.2 ppm by volume, a molecular hydrogen concentration of 12 ppm by volume, and an atomic phosphorus concentration of 0.5 ppb by volume. The results are shown in Table 1.

### Example 6

A high-pressure gas container was cleaned in the same manner as in Example 1 except that the depressurization step was performed to reduce the pressure until the internal pressure of the high-pressure gas container reached 5 Pa.

The high-pressure gas container after the cleaning step was refilled with 25 kg of hydrogen chloride having a moisture concentration of 0.2 ppm by volume or less. Then, the moisture concentration, the molecular hydrogen concentration, and the atomic phosphorus concentration of the hydrogen chloride charged in the high-pressure gas container were determined in the same manner as in Example 1. As a result, the hydrogen chloride had a moisture concentration of 0.9 ppm by volume, a molecular hydrogen concentration of 0.1 ppm by volume or less, and an atomic phosphorus concentration of 0.6 ppb by volume. The results are shown in Table 1.

### Example 7

A high-pressure gas container was cleaned in the same manner as in Example 1 except that the temperature in the depressurization step was changed to 50° C. or more and 55° C. or less.

The high-pressure gas container after the cleaning step was refilled with 25 kg of hydrogen chloride having a moisture concentration of 0.2 ppm by volume or less. Then, the moisture concentration, the molecular hydrogen concentration, and the atomic phosphorus concentration of the hydrogen chloride charged in the high-pressure gas container were determined in the same manner as in Example 1. As a result, the hydrogen chloride had a moisture concentration of 0.5 ppm by volume, a molecular hydrogen concentration of 0.1 ppm by volume or less, and an atomic phosphorus concentration of 0.5 ppb by volume. The results are shown in Table 1.

### Example 8

A high-pressure gas container was cleaned in the same manner as in Example 1 except that the temperature in the depressurization step was changed to 190° C. or more and 200° C. or less.

The high-pressure gas container after the cleaning step was refilled with 25 kg of hydrogen chloride having a moisture concentration of 0.2 ppm by volume or less. Then, the moisture concentration, the molecular hydrogen concentration, and the atomic phosphorus concentration of the hydrogen chloride charged in the high-pressure gas container were determined in the same manner as in Example 1. As a result, the hydrogen chloride had a moisture concentration of 0.2 ppm by volume, a molecular hydrogen concentration of 0.1 ppm by volume or less, and an atomic phosphorus concentration of 0.8 ppb by volume. The results are shown in Table 1.

### Example 9

A metal high-pressure gas container having a volume of 440 L was prepared (see FIG. 3). The inner face of the high-pressure gas container was polished so that the inner face of the body had a maximum height Rz of 1 μm, and the inner face of portions other than the body had a maximum height Rz of 20 μm. The inner face of the high-pressure gas container was not coated with any coating material.

The high-pressure gas container was cleaned in the same manner as in Example 1 except that the high-pressure gas container was changed from the container having a volume of 47 L to the container having a volume of 440 L, the temperature in the depressurization step was changed to 50° C. or more and 55° C. or less, the depressurization step was performed to reduce the pressure until the internal pressure of the high-pressure gas container reached 3 Pa, the amount of hydrogen chloride supplied in the hydrogen halide supply stage was 250 kg, and the cleaning step was performed once.

The high-pressure gas container after the cleaning step was refilled with 250 kg of hydrogen chloride having a moisture concentration of 0.2 ppm by volume or less. Then, the moisture concentration, the molecular hydrogen concentration, and the atomic phosphorus concentration of the hydrogen chloride charged in the high-pressure gas container were determined in the same manner as in Example 1. As a result, the hydrogen chloride had a moisture concentration of 0.6 ppm by volume, a molecular hydrogen concentration of 0.1 ppm by volume or less, and an atomic phosphorus concentration of 0.4 ppb by volume. The results are shown in Table 1.

### Example 10

A metal high-pressure gas container having a volume of 900 L was prepared (see FIG. 4). The inner face of the high-pressure gas container was polished so that the inner face of the body had a maximum height Rz of 1 μm, and the inner face of portions other than the body had a maximum height Rz of 20 μm. The inner face of the high-pressure gas container was not coated with any coating material.

The high-pressure gas container was cleaned in the same manner as in Example 1 except that the high-pressure gas container was changed from the container having a volume of 47 L to the container having a volume of 900 L, the temperature in the depressurization step was changed to 50° C. or more and 55° C. or less, the depressurization step was performed to reduce the pressure until the internal pressure of the high-pressure gas container reached 3 Pa, the amount of hydrogen chloride supplied in the hydrogen halide supply stage was 500 kg, and the cleaning step was performed twice.

The high-pressure gas container after the cleaning step was refilled with 500 kg of hydrogen chloride having a moisture concentration of 0.2 ppm by volume or less. Then, the moisture concentration, the molecular hydrogen concentration, and the atomic phosphorus concentration of the hydrogen chloride charged in the high-pressure gas container were determined in the same manner as in Example 1. As a result, the hydrogen chloride had a moisture concentration of 0.3 ppm by volume, a molecular hydrogen concentration of 0.1 ppm by volume or less, and an atomic phosphorus concentration of 0.7 ppb by volume. The results are shown in Table 1.

### Example 11

A high-pressure gas container was cleaned in the same manner as in Example 1 except that each inner face of the body and portions other than the body of the high-pressure gas container had a maximum height Rz of 20 μm, and the cleaning step was performed five times.

The high-pressure gas container after the cleaning step was refilled with 25 kg of hydrogen chloride having a moisture concentration of 0.2 ppm by volume or less. Then, the moisture concentration, the molecular hydrogen concentration, and the atomic phosphorus concentration of the hydrogen chloride charged in the high-pressure gas container were determined in the same manner as in Example 1. As a result, the hydrogen chloride had a moisture concentration of 0.8 ppm by volume, a molecular hydrogen concentration of 0.2 ppm by volume, and an atomic phosphorus concentration of 1.0 ppb by volume. The results are shown in Table 1.

### Example 12

A high-pressure gas container was cleaned in the same manner as in Example 1 except that the amount of hydrogen chloride supplied in the hydrogen halide supply stage was 2 kg, and the cleaning step was performed 20 times.

The high-pressure gas container after the cleaning step was refilled with 25 kg of hydrogen chloride having a moisture concentration of 0.2 ppm by volume or less. Then, the moisture concentration, the molecular hydrogen concentration, and the atomic phosphorus concentration of the hydrogen chloride charged in the high-pressure gas container were determined in the same manner as in Example 1. As a result, the hydrogen chloride had a moisture concentration of 1.2 ppm by volume, a molecular hydrogen concentration of 0.1 ppm by volume or less, and an atomic phosphorus concentration of 0.4 ppb by volume. The results are shown in Table 1.

### Comparative Example 1

A high-pressure gas container substantially the same as in Example 1 was subjected to the same treatment as in Example 1 except that the cleaning step was not performed.

The high-pressure gas container after the depressurization step was filled with 25 kg of hydrogen chloride having a moisture concentration of 0.2 ppm by volume or less. Then, the moisture concentration, the molecular hydrogen concentration, and the atomic phosphorus concentration of the hydrogen chloride charged in the high-pressure gas container were determined in the same manner as in Example 1. As a result, the hydrogen chloride had a moisture concentration of 3.6 ppm by volume, a molecular hydrogen concentration of 0.5 ppm by volume, and an atomic phosphorus concentration of 0.9 ppb by volume. The results are shown in Table 1.

### Comparative Example 2

A high-pressure gas container was cleaned in the same manner as in Example 1 except that temperature and pressure conditions in the depressurization step differed.

The high-pressure gas container after the cleaning step was refilled with 25 kg of hydrogen chloride having a moisture concentration of 0.2 ppm by volume or less. Then, the moisture concentration, the molecular hydrogen concentration, and the atomic phosphorus concentration of the hydrogen chloride charged in the high-pressure gas container were determined in the same manner as in Example 1. As a result, the hydrogen chloride had a moisture concentration of 2.5 ppm by volume, a molecular hydrogen concentration of 1.0 ppm by volume, and an atomic phosphorus concentration of 0.8 ppb by volume. The results are shown in Table 1.

### Comparative Example 3

A high-pressure gas container was cleaned in the same manner as in Example 1 except that pressure conditions in the depressurization step differed.

The high-pressure gas container after the cleaning step was refilled with 25 kg of hydrogen chloride having a moisture concentration of 0.2 ppm by volume or less. Then, the moisture concentration, the molecular hydrogen concentration, and the atomic phosphorus concentration of the hydrogen chloride charged in the high-pressure gas container were determined in the same manner as in Example 1. As a result, the hydrogen chloride had a moisture concentration of 1.6 ppm by volume, a molecular hydrogen concentration of 2.0 ppm by volume, and an atomic phosphorus concentration of 0.3 ppb by volume. The results are shown in Table 1.

### Reference Example 1

A high-pressure gas container substantially the same as in Example 1 was subjected to the same treatment as in Comparative Example 1 except that the inner face of the high-pressure gas container was coated by plating with nickel-phosphorus alloy as the coating material.

The high-pressure gas container after the depressurization step was filled with 25 kg of hydrogen chloride having a moisture concentration of 0.2 ppm by volume or less. Then, the moisture concentration, the molecular hydrogen concentration, and the atomic phosphorus concentration of the hydrogen chloride charged in the high-pressure gas container were determined in the same manner as in Example 1. As a result, the hydrogen chloride had a moisture concentration of 0.8 ppm by volume, a molecular hydrogen concentration of 0.2 ppm by volume, and an atomic phosphorus concentration of 2.1 ppb by volume. The results are shown in Table 1.

TABLE 1

| | | Ex. 1 | Ex. 2 | Ex. 3 | Ex. 4 | Ex. 5 | Ex. 6 | Ex. 7 | Ex. 8 |
|---|---|---|---|---|---|---|---|---|---|
| High- | Volume (L) | 47 | 47 | 47 | 47 | 47 | 47 | 47 | 47 |
| pressure | Maximum height | 1 | 1 | 5 | 1 | 1 | 1 | 1 | 1 |
| gas | Rz of inner | | | | | | | | |
| container | face of body | | | | | | | | |
| | (μm) | | | | | | | | |
| | Maximum height | 20 | 1 | 5 | 20 | 20 | 20 | 20 | 20 |
| | Rz of inner | | | | | | | | |
| | face of bottom | | | | | | | | |
| | (μm) | | | | | | | | |
| | Plating | Without | Without | Without | Without | Without | Without | Without | Without |
| Depres- | Temperature | 145-155 | 145-155 | 145-155 | 145-155 | 145-155 | 145-155 | 50-55 | 190-200 |
| surization | (° C.) | | | | | | | | |
| step | Pressure (Pa) | 0.01 or | 0.01 or | 0.01 or | 0.01 or | 0.01 or | 5 | 0.01 or | 0.01 or |
| | | less | less | less | less | less | | less | less |
| Cleaning | Type of HX | Hydrogen | Hydrogen | Hydrogen | Hydrogen | Hydrogen | Hydrogen | Hydrogen | Hydrogen |
| step | | chloride | chloride | chloride | bromide | chloride | chloride | chloride | chloride |
| | Filling amount | 25 | 25 | 25 | 20 | 25 | 25 | 25 | 25 |
| | of HX (kg) | | | | | | | | |
| | Reaction | 15-25 | 15-25 | 15-25 | 15-25 | 35-40 | 15-25 | 15-25 | 15-25 |
| | temperature | | | | | | | | |
| | (° C.) | | | | | | | | |
| | Reaction | 24 | 24 | 24 | 24 | 24 | 24 | 24 | 24 |
| | time (hours) | | | | | | | | |
| | Number of times | 4 | 1 | 2 | 4 | 1 | 4 | 4 | 4 |
| | of cleaning step | | | | | | | | |
| | (times) | | | | | | | | |
| HX | Type of HX | Hydrogen | Hydrogen | Hydrogen | Hydrogen | Hydrogen | Hydrogen | Hydrogen | Hydrogen |
| refilling | | chloride | chloride | chloride | bromide | chloride | chloride | chloride | chloride |
| | Filling amount | 25 | 25 | 25 | 20 | 25 | 25 | 25 | 25 |
| | of HX (kg) | | | | | | | | |
| Analysis | Moisture | 0.6 | 0.4 | 0.8 | 0.9 | 0.2 | 0.9 | 0.5 | 0.2 |
| result | concentration | | | | | | | | |
| | (ppm by volume) | | | | | | | | |
| | Molecular hydrogen | 0.1 or | 0.1 or | 1.0 | 0.1 or | 12 | 0.1 or | 0.1 or | 0.1 or |
| | concentration | less | less | | less | | less | less | less |
| | (ppm by volume) | | | | | | | | |
| | Atomic phosphorus | 0.5 | 0.9 | 0.7 | 0.9 | 0.5 | 0.6 | 0.5 | 0.8 |
| | concentration | | | | | | | | |
| | (ppb by volume) | | | | | | | | |
| | | | | | | Comp. | Comp. | Comp. | Ref. |
| | | Ex. 9 | Ex. 10 | Ex. 11 | Ex. 12 | Ex. 1 | Ex. 2 | Ex. 3 | Ex. 1 |
| High- | Volume (L) | 440 | 900 | 47 | 47 | 47 | 47 | 47 | 47 |
| pressure | Maximum height | 1 | 1 | 20 | 1 | 1 | 1 | 1 | — |
| gas | Rz of inner | | | | | | | | |
| container | face of body | | | | | | | | |
| | (μm) | | | | | | | | |
| | Maximum height | 20 | 20 | 20 | 20 | 20 | 20 | 20 | — |
| | Rz of inner | | | | | | | | |
| | face of bottom | | | | | | | | |
| | (μm) | | | | | | | | |
| | Plating | Without | Without | Without | Without | Without | Without | Without | With |
| Depres- | Temperature | 50-55 | 50-55 | 145-155 | 145-155 | 145-155 | 20-30 | 145-155 | 145-155 |
| surization | (° C.) | | | | | | | | |
| step | Pressure (Pa) | 3 | 3 | 0.01 or | 0.01 or | 0.01 or | 10 | 10 | 0.01 or |
| | | | | less | less | less | | | less |
| Cleaning | Type of HX | Hydrogen | Hydrogen | Hydrogen | Hydrogen | — | Hydrogen | Hydrogen | — |
| step | | chloride | chloride | chloride | chloride | | chloride | chloride | |
| | Filling amount | 250 | 500 | 25 | 2 | — | 25 | 25 | 25 |
| | of HX (kg) | | | | | | | | |
| | Reaction | 15-25 | 15-25 | 15-25 | 15-25 | — | 15-25 | 15-25 | — |
| | temperature | | | | | | | | |
| | (° C.) | | | | | | | | |
| | Reaction | 24 | 24 | 24 | 24 | — | 24 | 24 | — |
| | time (hours) | | | | | | | | |
| | Number of times | 1 | 2 | 5 | 20 | 0 | 4 | 4 | 0 |
| | of cleaning step | | | | | | | | |
| | (times) | | | | | | | | |
| HX | Type of HX | Hydrogen | Hydrogen | Hydrogen | Hydrogen | Hydrogen | Hydrogen | Hydrogen | Hydrogen |
| refilling | | chloride | chloride | chloride | chloride | chloride | chloride | chloride | chloride |
| | Filling amount | 250 | 500 | 25 | 25 | 25 | 25 | 25 | 25 |
| | of HX (kg) | | | | | | | | |
| Analysis | Moisture | 0.6 | 0.3 | 0.8 | 1.2 | 3.6 | 2.5 | 1.6 | 0.8 |
| result | concentration | | | | | | | | |
| | (ppm by volume) | | | | | | | | |
| | Molecular hydrogen | 0.1 or | 0.1 or | 0.2 | 0.1 or | 0.5 | 1.0 | 2.0 | 0.2 |
| | concentration | less | less | | less | | | | |
| | (ppm by volume) | | | | | | | | |
| | Atomic phosphorus | 0.4 | 0.7 | 1.0 | 0.4 | 0.9 | 0.8 | 0.3 | 2.1 |
| | concentration | | | | | | | | |
| | (ppb by volume) | | | | | | | | |

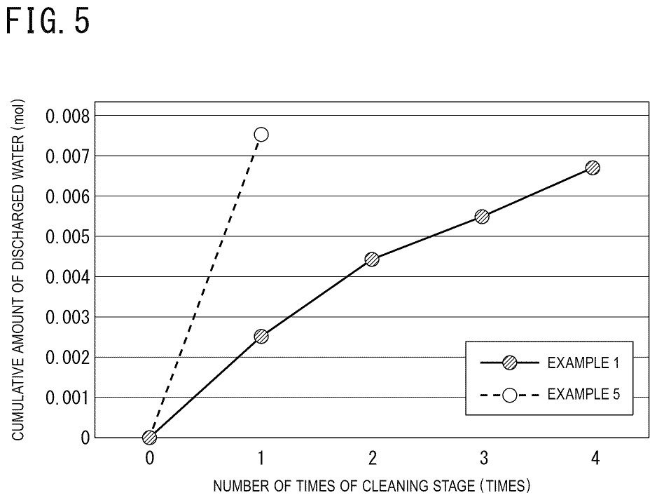

In Example 1 and Example 5, after every cleaning step, the moisture concentration of the hydrogen chloride discharged in the discharge stage was determined in the same manner as in Example 1. From the determined moisture concentration value, the amount (mol) of water discharged in one cleaning step was calculated. The results are illustrated in the graph in FIG. 5. The graph in FIG. 5 indicates cumulative amounts of discharged water.

The graph in FIG. 5 reveals that the total amount of discharged water was substantially the same in Example 1 and Example 5. The result indicates that a high temperature is not required in the metal oxide removal stage, and water can be removed even at less than 30° C.

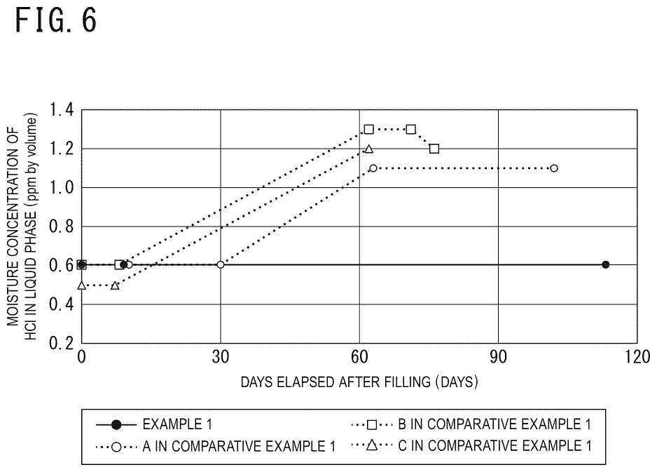

In Example 1, the high-pressure gas container refilled with 25 kg of hydrogen chloride after the cleaning step was allowed to stand in a room conditioned at a temperature of 20° C. or more and 25° C. or less. After a predefined time period, the moisture concentration of the hydrogen chloride charged in the high-pressure gas container was determined in the same manner as in Example 1. The results are illustrated in the graph in FIG. 6.

In a similar manner, in Comparative Example 1, the high-pressure gas container filled with 25 kg of hydrogen chloride after the depressurization step was allowed to stand in a room conditioned at a temperature of 20° C. or more and 25° C. or less. After a predefined time period, the moisture concentration of the hydrogen chloride charged in the high-pressure gas container was determined in the same manner as in Example 1. The results are illustrated in the graph in FIG. 6. For the test in Comparative Example 1, three high-pressure gas containers were prepared (in graph in FIG. 6, indicated by A in Comparative Example 1, B in Comparative Example 1, and C in Comparative Example 1), and each was subjected to substantially the same test.

The graph in FIG. 6 revealed that in Comparative Example 1, the moisture concentration increased after a month or more. In contrast, in Example 1, the moisture concentration did not increase even after three months or more. These results indicate that a metal oxide reacts with a hydrogen chloride to form water in the high-pressure gas container without the cleaning step but that the high-pressure gas container after the cleaning step contains no metal oxide.

### REFERENCE SIGNS LIST

1: helium cylinder for purging
2: pressure reducing valve
3, 4, 6, 8, 11: valve
5: hydrogen halide supply source
7: 47-L high-pressure gas container
9: pressure gauge
10: check valve
12: discharge means
13: nitrogen gas supply source
14, 15, 16: valve
17: vacuum pump
18: vacuum gauge
19: 47-L high-pressure gas container
20: heater
21: heat insulating material
22: temperature controller
23: fusible plug-cooling air supply source
120: gas phase container valve
121: gas phase siphon tube
122: liquid phase siphon tube
123: liquid phase container valve
124: 440-L high-pressure gas container
125: gas phase container valve
126: liquid phase container valve
127, 130: safety valve
128: gas phase siphon tube
129: liquid phase siphon tube
131, 133: skirt
132: 900-L high-pressure gas container

1. A method for cleaning a high-pressure gas container comprising:
a depressurization step of reducing a pressure in a high-pressure gas container until an internal pressure of the high-pressure gas container reaches 5 Pa or less; and
a cleaning step of cleaning an inside of the high-pressure gas container after the depressurization step, wherein
the cleaning step includes
a hydrogen halide supply stage of supplying a hydrogen halide to the high-pressure gas container after the depressurization step,
a metal oxide removal stage of reacting, in the high-pressure gas container after the hydrogen halide supply stage, a metal oxide on an inner face of the high-pressure gas container with the hydrogen halide supplied in the hydrogen halide supply stage to form water, and
a discharge stage of discharging the water formed in the metal oxide removal stage and the hydrogen halide supplied in the hydrogen halide supply stage from the high-pressure gas container.

2. The method for cleaning a high-pressure gas container according to claim 1, wherein the inner face of the high-pressure gas container is not coated with any coating material, and the inner face of a body of the high-pressure gas container has a maximum height Rz of 5 m or less.

3. The method for cleaning a high-pressure gas container according to claim 1, wherein the depressurization step is a step of discharging gas until the internal pressure reaches 5 Pa or less while the high-pressure gas container is maintained at a temperature of 50° C. or more and 200° C. or less.

4. The method for cleaning a high-pressure gas container according to claim 1, wherein the hydrogen halide is at least one of hydrogen fluoride, hydrogen chloride, hydrogen bromide, and hydrogen iodide.

5. The method for cleaning a high-pressure gas container according to claim 1, wherein the hydrogen halide supply stage is a step of supplying a hydrogen halide to the high-pressure gas container until the hydrogen halide is liquefied in the high-pressure gas container.

6. The method for cleaning a high-pressure gas container according to claim 1, wherein the metal oxide removal stage is a step of allowing the high-pressure gas container to which the hydrogen halide has been supplied in the hydrogen halide supply stage, to stand at a temperature of less than 30° C. for one day or more.

7. The method for cleaning a high-pressure gas container according to claim 1, wherein when the high-pressure gas container has a volume of 10 L or more and 50 L or less, the discharge stage is a step of turning the high-pressure gas container upside down to discharge the water and the hydrogen halide from the high-pressure gas container.

8. The method for cleaning a high-pressure gas container according to claim 1, wherein when the high-pressure gas container has a volume of more than 50 L and 1000 L or less, the discharge stage is a step of inserting an insertion tube into the high-pressure gas container and using the insertion tube to discharge the water and the hydrogen halide in a liquid phase from the high-pressure gas container.

9. The method for cleaning a high-pressure gas container according to claim 1, wherein after the depressurization step, the cleaning step is repeated twice or more.

10. The method for cleaning a high-pressure gas container according to claim 1, wherein the metal oxide is at least one of iron oxide, chromium oxide, molybdenum oxide, and manganese oxide.

11. The method for cleaning a high-pressure gas container according to claim 2, wherein the depressurization step is a step of discharging gas until the internal pressure reaches 5 Pa or less while the high-pressure gas container is maintained at a temperature of 50° C. or more and 200° C. or less.

12. The method for cleaning a high-pressure gas container according to claim 2, wherein the hydrogen halide is at least one of hydrogen fluoride, hydrogen chloride, hydrogen bromide, and hydrogen iodide.

13. The method for cleaning a high-pressure gas container according to claim 2, wherein the hydrogen halide supply stage is a step of supplying a hydrogen halide to the high-pressure gas container until the hydrogen halide is liquefied in the high-pressure gas container.

14. The method for cleaning a high-pressure gas container according to claim 2, wherein the metal oxide removal stage is a step of allowing the high-pressure gas container to which the hydrogen halide has been supplied in the hydrogen halide supply stage, to stand at a temperature of less than 30° C. for one day or more.

15. The method for cleaning a high-pressure gas container according to claim 2, wherein when the high-pressure gas container has a volume of 10 L or more and 50 L or less, the discharge stage is a step of turning the high-pressure gas container upside down to discharge the water and the hydrogen halide from the high-pressure gas container.

16. The method for cleaning a high-pressure gas container according to claim 2, wherein when the high-pressure gas container has a volume of more than 50 L and 1000 L or less, the discharge stage is a step of inserting an insertion tube into the high-pressure gas container and using the insertion tube to discharge the water and the hydrogen halide in a liquid phase from the high-pressure gas container.

17. The method for cleaning a high-pressure gas container according to claim 2, wherein after the depressurization step, the cleaning step is repeated twice or more.

18. The method for cleaning a high-pressure gas container according to claim 2, wherein the metal oxide is at least one of iron oxide, chromium oxide, molybdenum oxide, and manganese oxide.
